(19) United States
(12) Patent Application Publication
(10) Pub. No.: US 2026/0169165 A1
(43) Pub. Date: Jun. 18, 2026

(54) DETECTING AN OBJECT IN A SPACE

(71) Applicant: I R Kinetics Limited, Earby (GB)

(72) Inventor: Andrew Bradley, Earby (GB)

(21) Appl. No.: 19/129,284

(22) PCT Filed: Nov. 29, 2023
(86) PCT No.: PCT/GB2023/053093

§ 371 Date: May 12, 2025

(30) Foreign Application Priority Data
Nov. 29, 2022 (GB) 2217942.8

(51) Int. Cl. G01S 17/48; G01S 7/48; G01S 17/66; G01S 17/89; G01S 17/933; G06T 7/73

(52) U.S. Cl. CPC G01S 17/48; G01S 7/4808; G01S 17/66; G01S 17/89; G01S 17/933; G06T 7/75; G06T 2207/10028; G06T 2207/10048; G06T 2207/20084

(57) ABSTRACT

A computer implemented method of detecting a first object in a space (500) comprises: i) receiving data about one or more detections made by at least one narrow-band infrared sensor of infrared radiation in the narrow-band coming from a first marker placed at a first point on the first object. The method then comprises ii) determining the location of the first point in the space from locations of the detected signals in the received data. The space (500) may be a factory or outdoor construction site, where a large article (512) is being manufactured. The large article (512) has a plurality of markers on its surface which emit or reflect infrared, I R, radiation. IR sensors (204) are positioned at different points in the space and send data on detections of the markers to an IR Sensor Control module (502) of a computer node (100). A Position Determining Engine (504) determines the location of each of the points corresponding to the markers in the space from locations of the detected signals in the received data. A Robot Movement Controller module (506) uses the determined locations to determine e.g. orientation and/or positioning/postural information about robots (508a, 508b, 508c) and determines actions to be performed by the robots. Markers may also be placed on the people (510) working in the space (500) to track their movements in relation to the robots. Proximity alerts can be issued if someone gets too close to the automated machinery.

### FIELD

The disclosure herein relates to object detection, monitoring and tracking. It further relates to the precise detection, monitoring and tracking of objects to enhance efficiency, safety and automation. It further relates to tracking and monitoring robots, drones, other machinery and operatives in smart manufacturing, construction and inspection environments, amongst others.

### BACKGROUND

The disclosure herein relates to tracking objects, such as robots in factory settings. Various manufacturing settings use robotics. For example, the automotive industry has been applying robotics for many decades, in particular, removing human operators from dull, dirty, dangerous and strenuous operations whilst reducing costs, improving quality and speeding up production lines.

More recently robots have been applied to work collaboratively and safely with humans as so-called “cobots”. Factory robotic tasking now extends to material handling, internal logistics, inspection, packaging, dispatch and through life maintenance, as well as the more traditional fabrication, assembly and finishing lines.

A defining feature of the application of robotics to manufacturing has been the mechanical earthing of the robot bodies and thereby of the robotic arms, in combination with the fixing of the article being manufactured in relation to the earthed robot bodies. Typically, a production line moves a manufactured article from one station to the next. This strategy enables both the precise relative alignment of the manufactured article with the robotic arms and the precise control of the many degrees of freedom of the robotic arms through pre-programmed movement instructions.

### SUMMARY OF INVENTION

As described in the background section, robotic production lines currently tend to move an article, such as a car along the production line, from one manufacturing station to the next. However, as the size and complexity of the manufactured article increases for products such as aircraft, trains, ships, submarines and spaceships, it becomes increasingly impractical to move an article along a production line frequently or rapidly enough in relation to mechanically earthed robots. Hence it is becoming increasingly desirable to be able to deploy robots and “cobots” that are not fixed in place but that can move efficiently around, about and even within a manufactured or built article, be it a ‘positive’ structure such as a building or a ‘negative’ structure such as a tunnel.

This logic extends naturally to many realms including manufacturing, civil engineering and agriculture, etc where the house or the article to be made, the bridge to be built, the material to be tunnelled, the land to be farmed, etc are de facto stationary.

The benefits of precision farming are now being widely enjoyed based on satellite imaging and the 10 cm accuracy that high end GPS/GNSS navigation can bring to slow moving machinery in relatively open farming spaces. However, this level of accuracy simply isn't high enough for mobile plant, equipment and machinery to be able to operate at much higher speeds than agricultural machinery either in factories or in towns and cities, where GPS is also less reliable. Higher levels of positioning accuracy are required, for example, in the robotic assembly of premanufactured building sections, where a Local Positioning System (LPS) is required that can provide accurate, near real-time (low latency) measurement of machine position in a space including the precise measurement of the movement of its key moving parts/limbs, in a collaborative, agile and safe manner.

There are several existing Local Positioning Systems (LPS) technologies based on Radio Frequency (RF) emitters being fitted to mobile objects and RF receivers being placed around the operations site or factory, working together to calculate the location and trajectories of the emitters. These have accuracy limitations when the movements being measured involve high speeds or significant accelerations. Hence, they can track slow moving robots moving around a warehouse but cannot track fast moving robot arms with the required accuracies and latencies. There are also LPS technologies based on video camera image processing or photogrammetry which have latency and sheer computational complexity barriers, particularly when the situations being measured are not purely repetitive.

Accuracy isn't the only issue in these smart-manufacturing & construction applications. To truly leverage the potential of such systems, it is increasingly desirable for machines, robots, drones and the like to be able to work independently outdoors and in a range of weather conditions, both day and night. It is also desirable for robots, drones and the like to be able to work across large distances, such as the large distances involved in large construction, fabrication, inspection and maintenance environments, both indoor and outdoor, above ground and underground.

It is an object of embodiments herein to address some of these issues, amongst others.

According to a first aspect herein, there is a computer implemented method of detecting a first object in a space. The method comprises i) receiving data about one or more detections made by at least one narrow-band infrared sensor of infrared radiation in the narrow-band coming from (e.g. reflecting or being emitted from) a first marker placed at a first point on the first object; and ii) determining the location of the first point in the space from locations of the detected signals in the received data.

In some embodiments, the narrow-band signal is centred at about 800 nm with a frequency range of about +/−10 nm or a frequency range of about +/−20 nm.

There is thus provided a method for locating a point on an object using an infrared marker and a narrow-band infrared sensor. There are significant advantages associated with the use of narrow-band detections in this manner. In particular, the narrow-band detections have a much higher signal to noise ratio than unfiltered, broadband detections. This enables the detections to be made reliably with the high accuracy needed for such applications (typically less than ˜5 cm) over much larger distances (at the time of writing to the order of ˜100 m). These distances can be obtained even in poor weather conditions, day or night. The measurements remain accurate, even when an object is moving quickly or accelerating. Furthermore, the markers in embodiments herein (IR reflectors or emitters) are generally at least as cost effective as systems such as active RFID tags. Such systems may be used in a range of scenarios, such as for example, tracking humans or animals, on sports pitches or sports fields.

The techniques can further advantageously be deployed in smart-factory and smart-manufacturing settings as described above where the narrow-bands can be used to locate (with high precision) markers located at particular points on humans, machinery, robots, drones etc with high precision at long distances.

Thus, the systems and methods herein can be used to monitor the positions of objects such as manually operated machines, remotely controlled machines, autonomous machines and robots, cobots, drones, other mechanical systems and human operatives with high precision, at the required range, night or day and in a wide range of weather conditions. The high accuracy positional data over long ranges can be used to send instructions to any of these object types, for co-ordination of robots with other robots, machinery and/or people at an industrial site. Thus, described herein are LPS systems that are accurate enough at long enough range to be used in the manufacture of particularly large, or stationary objects. The systems herein thus enable smart manufacturing of trains, aeroplanes, bridges, submarines and the like, amongst other applications.

In some embodiments, steps i) and ii) are repeated in an iterative manner to track movements of the first point on the first object over time.

In some embodiments, the method further comprises instructing an Infrared emitter to emit pulses of Infrared radiation into the space wherein the pulses are emitted with a first frequency of pulsation. Steps i) and ii) are then repeated for detections of reflections of each pulse from the first marker. As an example, the pulses can be emitted with a frequency of pulsation between about 60 and about 100 Hz. Using IR emitters in a pulsed manner as opposed to keeping them on all the time is advantageous in reducing the energy used by the emitters, while still enabling high accuracy near-real time tracking.

In some embodiments, steps i) and ii) are repeated for infrared radiation coming from two or more different markers placed at two or more different points on the first object.

For example, in some embodiments, step i) comprises: receiving data about a point-cloud of detections made by at least one narrow-band infrared sensor of infrared radiation in the narrow-band coming from a plurality of markers placed at a plurality of points on the first object. Step ii) may further comprise determining, from the point cloud, an orientation, position or posture of the first object in the space.

In some embodiments, the method further comprises using the stream of location, orientation and positional information for the first object to determine an action or manoeuvre to be performed by the first object; and sending a control signal to the first object, to cause the first object to perform the action or manoeuvre. Thus, the methods herein can be used to automate the control of drones, machines and the like in smart-manufacturing and construction settings.

In some embodiments, the method further comprises repeating steps i) and ii) for a second marker placed on a second point on a second object, to determine the location of the second point in the space, and using the determined locations of the first marker and the second marker to determine a relative proximity of the first object and the second object. In some examples, the relative proximity is used to initiate a proximity warning, or send a command to halt or change movement of the first object or the second object, in response to determining that the relative proximity is less than a first threshold proximity. Thus, the methods herein can be used to improve safety in automated factory or manufacturing settings and the like, particularly if the second object is a person.

In some embodiments, the first object is a robot, drone, mechanical object or person. In some embodiments, the space is a construction site, factory or field. In some embodiments, the first object is a building, bridge, or wind-turbine. In some embodiments, the second object is a second robot, a second drone or a human.

In some embodiments, the data in step i) is received from a drone and the method further comprises: causing the drone to make measurements of the first object, using the determined location of the first point in the space as a reference point with which to align the drone to the first object before the measurements are made. Thus, in this way, a marker can be used by a drone to accurately and reliably locate a particular point or vantage point with respect to a large object such as a wind turbine, from which to make measurements of the first object. This can be used to ensure that measurements are made in a repeatable, reliable manner so that the condition of the object can be monitored over time (e.g. for cracks, paint detects, structural changes and the like).

In some embodiments herein, triangulation is used in step ii) to determine the location of the marker(s).

In some embodiments, the method is performed at night, outdoors and/or in adverse weather conditions. The method can thus be used to permit 24 hr, all-weather manufacturing and construction.

According to a second aspect there is a method for tracking a first object, wherein the first object is a robot, drone or other machinery in a manufacturing or construction space. The method comprises: i) receiving data about detections made by the at least one infrared sensor of infrared radiation coming from a first infrared marker; and ii) determining the location of the robot, drone or machinery in the space, from locations of the detected signals in the received data. In some embodiments, the infrared sensor may be a narrow-band infrared sensor.

There are significant advantages to the use of infrared markers for use in the manufacturing and construction industries. In particular, the use of infrared emitting or reflective markers to locate robots, drones and other machinery enables said machinery to be used at night, and even in poor weather conditions, thus facilitating 24-hour manufacturing processes. As noted above, Infrared applied in this way is accurate on scales of less than 5 cm and has this accuracy even when an object is moving or accelerating. This is valuable in many areas of industry, such as automated factories, as well as in civil engineering applications such as the construction of buildings, bridges, and other infrastructure. Thus, there is provided systems and methods for precise detection, monitoring and tracking of objects in smart manufacturing, construction and inspection environments.

According to a third aspect there is a computer node comprising one or more processors configured to perform the method of the first aspect or the method of the second aspect.

According to a fourth aspect there is a system for tracking a first object in a space. The system comprises: a first marker placed at a first point on the first object, at least one narrow-band infrared sensor comprising a narrow-band infrared filter to detect infrared radiation in the narrow-band, and a computer node. The computer node comprises one or more processors configured to: i) receive data about one or more detections made by the at least one narrow band infrared sensor of infrared radiation in the narrow-band coming from the first marker; and ii) determine the location of the first point in the space from locations of the detected signals in the received data.

In some embodiments, the narrow-band infrared filter is centred at about 800 nm with a frequency range of about +/−10 nm or a frequency range of about +/−20 nm.

In some embodiments, the marker comprises an infrared emitter, a reflective material, or a retroreflective material.

In some embodiments, the system further comprises: one or more infrared lamps configured to illuminate the space with infrared radiation so as to cause infrared radiation to be reflected from the marker.

In some embodiments, the one or more infrared lamps are configured to emit pulses of infrared radiation with a first frequency of pulsation, and wherein the computer node is configured to repeat steps i) and ii) for each pulse.

In some embodiments, the computer node is further configured to perform the method of the first aspect.

According to a fifth aspect there is a computer program comprising instructions which, when executed by a computer cause the computer to perform the method of the first aspect or the second aspect.

According to a sixth aspect there is a computer readable storage medium comprising instructions which when executed by a computer cause the computer to carry out the method of the first aspect or the second aspect.

### DRAWINGS

Example embodiments herein will be described with respect to the following drawings in which:

FIG. 1a shows an example computer node according to embodiments herein;

FIG. 1b illustrates various components that the computer node of FIG. 1a may interface with;

FIG. 2 shows an example of how the computer node and components of FIGS. 1a and 1b may be used to track one or more objects in a factory setting;

FIG. 3a shows an example computer implemented method of detecting a first object in a space according to some embodiments herein;

FIG. 3b shows an extension of the method in FIG. 3a for obtaining a stream of positional information for the first point on the first object according to embodiments herein;

FIG. 3c shows an extension of the method of FIG. 3a to a point-cloud of detections of a plurality of markers placed on the first object according to embodiments herein;

FIG. 4a shows example markers on an example item of machinery, and the resulting point cloud generated therefrom, according to an example herein;

FIG. 4b shows the machinery in FIG. 4a at various different locations and poses and the resulting point-clouds;

FIG. 4c shows an extension of the method of FIG. 3c for use in controlling a manoeuvre of the first object;

FIG. 5a shows an example system in a manufacturing or construction environment, such as a factory according to some embodiments herein;

FIG. 5b shows an example method performed by the computer node illustrated in FIG. 5a according to some embodiments herein;

FIG. 6a shows an example application of the methods herein to the monitoring of large objects such as wind-turbines;

FIG. 6b shows an example extension of the method shown in FIG. 3a for use in positioning a drone to make accurate measurements of a first object.

### DESCRIPTION

In brief, the technology, systems and methods described herein are for use in tracking objects, particularly, but non-exclusively in factory and/or construction settings. For example, mobile objects. The objects may be in fixed environments and/or be mechanically earthed objects. Some embodiments herein use infrared video image processing and Near Infra-Red (NIR) cameras with NIR filters and/or narrow-band IR filters and lenses at fixed locations around a site or factory, together with the attachment of matching NIR emitting markers (LEDs) or retro-reflective markers to the plant and/or machinery involved in the manufacturing or construction and/or to the mechanically earthed product that is being constructed. Such markers can also be fitted to human operators working in the vicinity.

In the case of NIR retroreflective markers, these can be effective in natural daylight conditions by providing easily identified markings that reflect and absorb the ambient light. They can also be effective outdoors at night and in closed or even lights-out factories in combination with NIR floodlamps located close to the detection cameras. In the case of narrow-band infrared filters, these are advantageous as they result in low signal-to-noise detections, and thus narrow-band systems can be used to increase the range of detection (even at night and/or in poor weather conditions).

Embodiments herein use the detected reflections/emissions from such markers to determine the location, orientation and position/posture of the object(s) to which they are attached. The methods herein use near real-time computation methods (e.g., with the low latency necessary for closed-loop robotic control), such as, for example, triangulation or higher order multilateration, that allow the reflective/emissive markers to be tracked continuously and extremely accurately-down to <5 cm level. The systems and methods herein can be used either to monitor movements and provide proximity warnings or stops, thus increasing safety levels on sites and in factories, or they can be used directly in closed loop robotic control applications to provide increased levels of automation and efficiency.

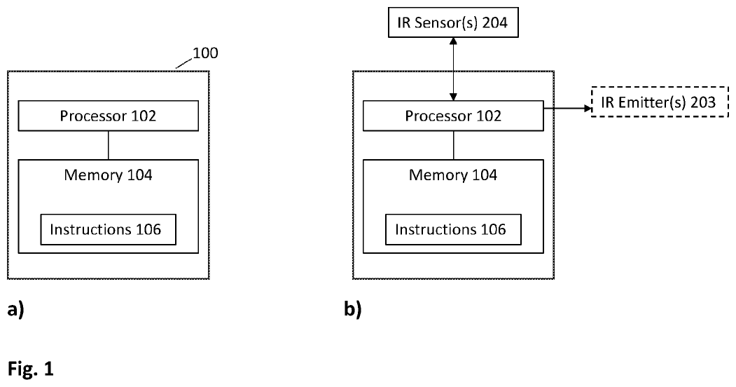

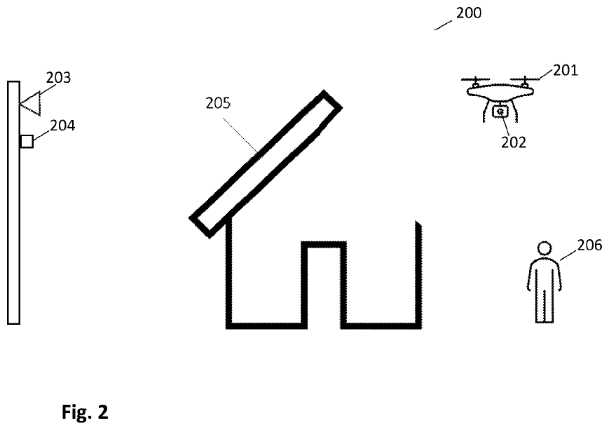

In more detail, and turning to FIG. 1a, in some embodiments, there is a computer node 100. The computer node 100 is for (e.g. configured to) detect a first object in a space. A computer node 100 may generally be configured (e.g. operative) to perform any of the methods and functions described herein, such as the method 300 described below. Computer node 100 comprises a processor 102, a memory 104 and set of instructions 106. The memory holds instruction data (e.g. such as compiled code) representing a set of instructions 106. The processor may be configured to communicate with the memory and to execute the set of instructions. The set of instructions, when executed by the processor, may cause the processor to perform any of the methods herein, such as the method 300 described below.

Processor (e.g. processing circuitry or logic) 102 may be any type of processor, such as, for example, a central processing unit (CPU), a Graphics Processing Unit (GPU), a Neural Processing Unit (NPU), or any other type of processing unit. Processor 102 may comprise one or more sub-processors, processing units, multi-core processors or modules that are configured to work together in a distributed manner to control the computer node in the manner described herein.

The computer node 100 may comprise a memory 104. In some embodiments, the memory 104 of the computer node 100 can be configured to store program code or instructions that can be executed by the processor 102 of the computer node 100 to perform the functionality described herein. The memory 104 of the computer node 100, may be configured to store any data or information referred to herein, such as for example, requests, resources, information, data, signals, or similar that are described herein. The processor 102 of the computer node 100 may be configured to control the memory 104 of the computer node 100 to store such information.

In some embodiments, the computer node 100 may be a virtual computer node, e.g. such as a virtual machine or any other containerised computer node. In such embodiments, the processor 102 and the memory 104 may be portions of larger processing and memory resources respectively. In some examples, the computer node 100 may thus be cloud-based.

It will be appreciated that a computer node 100 may comprise other components to those illustrated in FIG. 1a. For example, computer node 100 may comprise a power supply (e.g. mains or battery power supply). The computer node 100 may further comprise a wireless transmitter and/or wireless receiver to communicate wirelessly with other computing nodes and/or sensors e.g. such as IR sensors that detect the IR signals described herein. In some embodiments, the computer node 100 may have a wired connection with which to communicate with other computer nodes, IR sensors and the like.

As illustrated in FIG. 1b, in embodiments herein, the computer node 100 can communicate with (e.g. send and receive electronic messages to and from) one or more IR sensors 204 (which may be otherwise referred to as IR receivers or IR detectors). In some embodiments herein, the computer node 100 is further configured to send messages to one or more IR emitters 203, to e.g. control when emissions are made.

Briefly, in embodiments herein, the computer node is configured to detect a first object in a space. The computer node is configured to receive data about one or more detections made by at least one infrared (IR) sensor of infrared radiation from a first marker placed at a first point on the first object. The computer node is then further configured to determine (information about) the location of the first point in the space from locations of the detected signals in the received data.

As will be described in more detail below, in some embodiments herein, the first object is a robot, drone, or any other machinery for use in a manufacturing or factory setting. Thus, the systems and methods herein can be used to track and subsequently send control instructions to robots and the like in smart-factory set-ups. There are a variety of advantages of the use of infrared-based markers for tracking robots, machinery, drones and people in manufacturing settings, both automated, semi-automated and/or non-automated settings. The determined locations can be used to instruct automated or semi-automated machinery and/or create proximity alerts to reduce collisions. Infrared in particular is advantageous because it can be used at night (permitting “lights-out” manufacturing and round the clock construction) and in adverse weather conditions (permitting e.g. 24 hr construction work on bridges, and buildings, etc no matter the weather).

As noted above, the computer node 100 is for detecting (and monitoring) a first object in a space. The first object is fitted with a first marker at a first point on the first object. The marker can emit IR radiation (e.g. in the manner of a beacon) or reflect IR radiation emitted by an IR emitter. In some embodiments, where the marker emits IR, the marker may comprise an IR bulb or IR radiation source. As such the markers may be infrared beacons. As described below, in any of the embodiments herein, infrared may be replaced by near-infrared and thus the markers may equally be near-infrared beacons.

In embodiments where the marker reflects IR radiation, then the marker may comprise a reflective surface. In some embodiments, the marker comprises a retroreflective material. Retroreflective materials reflect electromagnetic radiation such that the angle of incidence, θᵢ, of the radiation is equal to the angle of reflection, θᵣ, e.g. θᵢ=θᵣ. Retroreflectors are advantageous for object tracking for this reason. In embodiments where the marker reflects IR radiation, then there may be a source of Infrared emission 203 (e.g. an IR bulb, lamp, floodlamp or similar) that emits IR radiation into the space (and reflects off the marker). In some embodiments, there may be more than one source of infrared radiation. For example, there may be a plurality of infrared lamps that illuminate the space (in a similar manner to floodlights).

It will be appreciated that the first object may be fitted with more than one marker. In some embodiments, the first object has a plurality of markers attached to it at a plurality of different locations on the first object. Each marker may emit or reflect infrared radiation. In such examples, the detections of the plurality of markers make a “point-cloud” of different points, each indicating a different point on the object.

Markers may be placed with different strategies. For example, they may be placed to form a triangular mesh configuration across the surface of the object. In such examples, the point cloud of detections may be used to form a three-dimensional outline of the surface of the object.

Markers may be placed at mechanical joints of the first object, and as such, the markers can trace the positions of moveable limbs of the first object. In such embodiments, drawing lines between such joints gives the outline of the skeleton of the first object. Markers can further be placed at the extremities of the object, such as at the end of a mechanical limb, for example, so that the extremity can be monitored and a proximity alarm can be raised if the limb moves in a dangerous manner.

The number of markers on each object will depend on the application. As an example, four markers, in different planes may be used to track an object in three dimensions. In the general case, a mesh of at least 4 markers not all in the same plane may be used, in addition to knowledge of the positions of those points in the frame of the object, to determine position and orientation in space of an object. If an object has moving parts, then at least 4 markers may be placed on each moving component of the whole object. However, if components of an object have restricted degrees of freedom (e.g. such as components that can only move up and down in a 2D plane) then less markers will needed.

It will further be appreciated that different patterns or reflective properties may be used to indicate different positions on the first object, or to identify particular markers. For example, the markers may be configured so that they emit or reflect different wavelengths of infrared radiation. As another example, where the markers comprise infrared emitters, these may be configured to emit different patterns of pulsed infrared radiation, in the manner of codes.

In examples where there are a plurality of different objects, that are each tracked, then different patterns or reflective properties may be used to distinguish a first plurality of markers on the first object from a second plurality of markers on a second object. For example, the markers on the first object may be configured so that they reflect different wavelengths of infrared radiation (or in different narrow bands) to the markers on the second object, or with different patterns.

In other embodiments, patterns, frequencies of emission/reflection, and or pulsed codes of emission may further be used to identify the type of object being detected. For example, different patterns may be associated with different types of objects. As an example, patterns can be used to differentiate classes of vehicles (e.g. different domino patterns on the roof for car, hgv, Igv, bus, . . . ). This can also be applied to diggers, dumper trucks, scrapers, surface layers, etc. Furthermore, the emitters/reflectors can also be configured to form barcodes, QR codes or any other identifiable type of markers to identify individual machines.

In some embodiments, where the markers emit IR radiation, a first plurality of markers on the first object may be configured to emit pulses of IR radiation at a first frequency of pulsation (e.g. with a first time period between pulses). And the second plurality of markers on the second object may be configured to emit pulses of IR radiation at a second frequency of pulsation. There are various advantages to pulsed emissions, including but not limited to, energy savings associated with periodically turning the IR emitters on and off. Furthermore, the timings may be co-ordinated such that the first plurality of markers are emitting (e.g. “on”) while the second plurality of markers are “off”, and vice versa. This can be used to group or distinguish the markers in the first plurality of markers, from markers in the second plurality of markers (e.g. to distinguish between two point-clouds).

In embodiments herein, the markers are detected by at least one IR sensor 204 (which may otherwise be referred to as an IR receiver or detector) which can comprise one or more IR cameras that may be used to capture the signals and generate photographs or images of the patterns. IR cameras and/or video equipment can also be used to capture IR signal patterns in a video stream, at a defined frame update rate.

As will be described in more detail below, in any of the embodiments herein, the infrared sensor 204 can be a narrow-band infrared sensor and the data received can comprise one or more detections of infrared radiation in the narrow-band from (e.g. emitted from or reflected off of) the first marker. For example, the infrared sensor 204 may be fitted with a narrow band filter. In principle any narrow-band Infrared filter may be used. In some examples, the narrow-band signal is centred at about 850 nm and has a width (e.g. a half-height frequency range) of about +/−10 nm or width of about +/−20 nm. The use of narrow-band IR detectors in this way has a number of significant advantages, including increased signal to noise and de-cluttering of the detections of the emissions or reflections from the marker(s). This increase in signal to noise enables detection of the markers over much higher distances compared to wide-band IR detectors. The range of detection is of the order of 100 m at current IR camera sensitivity levels (this will increase in future). Through the use of narrow-band Infrared, high signal-to noise is achievable in a variety of weather conditions, which is advantageous for applications to e.g. outdoor construction, manufacturing and farming. It is also advantageous to construction scenarios where the methods herein might be applied to e.g. the building of houses, buildings, sky-scrapers, bridges etc). Narrow-band infrared detections can also be made at night, permitting 24 hour construction projects. The narrow band may be centred on the peak transmittance of near-infrared in air, increasing the signal to noise ratio further.

It is further noted, that in embodiments herein, there may be more than one IR sensor. For example, two or more sensors may be provided that are spatially offset from one another. Spatially offset sensors have different vantage points and the offsets in the detected positions of the first marker and the relative positions of the IR sensors themselves can be used to triangulate the relative and/or absolute positions of the markers. In the case of triangulation, at least 2 IR sensors may be used, however 3 or 4 may be used dependent on the accuracy required for a particular application.

In embodiments where different markers reflect at different wavelengths, the IR sensors may be configured with different filters to track different groups of markers (such as markers fixed to first and second objects). As another example, different subsets of IR sensors may be configured to detect in different wavebands.

In embodiments where the marker(s) comprise reflective material to reflect IR radiation, IR emitters are also employed to illuminate the space. In embodiments where the IR receivers are narrow band receivers, is noted that any IR emitter(s) 203 in such embodiments may also comprise one or more filters to emit either in the same narrow-band as the narrow-band IR receivers, or in an overlapping band to the narrow-band IR receivers.

In embodiments where IR emitter(s) 203 are employed (e. g where the markers are reflective or retroreflective markers), these may be co-located with the IR receivers. For example, pairs or IR emitters and receivers may be placed on a lamp-post or mast type arrangement. It will be appreciated however that the emitters and receivers do not have to be co-located. It will also be appreciated that it is also possible to have moveable emitters. As an example of moveable emitters, IR emitters may be installed on drones, for flexible illumination of the space.

In some embodiments, where there are IR emitters emitting into the space (and reflective markers), the IR emitters may be configured to emit pulses of IR radiation into the space. For example, pulses may be emitted at a frequency between about 60 Hz and about 100 Hz (e.g. pulses emitted at intervals of between about 10 ms⁻¹ and about 16 ms⁻¹). The receivers may be configured to receive the pulses (e.g. the shutter speed of an IR camera may be set to the same frequency as the IR emitter is emitting the pulses at, and/or and synchronised using either wired or wireless signalling). This can save energy, while still enabling near-real time tracking of objects. The energy saving is even more significant in embodiments where the IR emitters emit into the space in the manner of flood-lights.

As used to herein, the term “space” is used to denote the three-dimensional volume in which the first object is located or moving within. Put another way, the physical three-dimensional space in which the first object is located, employed or operates.

The first object can be any type of object. The first object may be stationary or moving. The first object may be automated, semi-automated or fully controlled, e.g. by a human operator or engineer.

In some embodiments, the space can be a manufacturing space, e.g. such as a factory, warehouse, outdoor construction site, or any other site where manufacturing is performed. In this sense, the space is the physical three-dimensional space or volume in which the manufacturing is performed. In such embodiments, the first object may be a robot, drone, machinery or any other mechanical equipment that is engaged in manufacturing tasks. The first object (e.g. the robot or drone) may perform the manufacturing tasks in a fully-automated, semi-automated or manually controlled manner. The computer node 100 and/or the method 300 may be used to send instructions, guidance or more generally information that may be used in control processes for the first object.

FIG. 2 shows an example in which the space 200 is a construction site on which a building 205 is being built. The construction site comprises drones and/or robots 201. The drones and robots are configured to move around the building as it is being constructed. In FIG. 2 the object under construction is a building 205, however it will be appreciated that this is merely an example and the object 205 could be any other object (e.g. a submarine, bridge, large vehicle, aeroplane etc). In this example, drone 201 is fitted with a marker 202 (e.g. drone 201 is an example of a first object as described herein). In this example the marker 202 comprises a reflective material. An IR emitter 203 emits IR radiation into the space and this is reflected from the reflective material on the marker 202 and detected by IR radiation receivers(s) 204. The IR receivers 204 can be broadband receivers, or narrow band receivers as described above. In this example, the IR emitters 203 and receivers 204 are mounted on a post (in the manner of a lamp-post or flood-light stand). In this way, the IR emitters 203 can flood the space with IR radiation. It will be appreciated that further markers may be positioned on the drone 201, to build up a plurality of point locations for the drone. It will further be appreciated that markers can be placed on the building 205 that is being constructed and/or people 206 working in the space 200 as well as any other drones and/or robots in the space 200. In this way, the relative positions of the drone(s), people and stationary objects in the space can be accurately tracked in real-time.

In some embodiments, the space can be a construction site for a building or other civil engineering project, such as a bridge or other infrastructure. In such embodiments, the method 300 may be used for the purposes of automated or semi-automated construction. In such embodiments, the space is the construction site in which the building, bridge or other infrastructure is being constructed. In such embodiments, the first object may be a robot, drone, vehicle, or any other mechanical equipment that is engaged in construction tasks. In embodiments where the first object is a structure, the structure can be “positive” (e.g. a building going up or a road being laid) or “negative” (e.g. a foundations hole in the ground or a tunnel being dug).

It will be appreciated that the space may be the space within an object or building. Thus, the space can be the three-dimensional space within a warehouse or factory. In other examples, the space can be the space within an object being constructed, e.g. the inside of a submarine, train, or building. In embodiments where the embodiments herein are applied to the inside of an object under construction (e.g. where the first object is a robot or drone working inside a large object under construction) then moveable IR sensors and/or emitters, such as drone mounted emitters/receivers may be deployed in the interior of the object under construction.

In some embodiments, the space is a field or other farming space and the first object is farm-yard machinery such as a tractor, combine harvester, digger, or any other farm machinery. The method 300 described below may be used to detect the location of the machinery and provide instructions for the automated movements of the machinery across the land. The high accuracy, long range potential of the methods herein facilitates highly accurate automated farming applications, at night, and in poor weather conditions, thus supporting the provision of truly 24-hr agricultural applications.

In some embodiments herein, there is also a second object in the space. In such embodiments, the second object may be a second robot, drone, or any other type of mechanical equipment.

In other embodiments, the second object may be a person (e.g. such as an Engineer, Builder or Construction worker) operating in the space. In such embodiments, the method 300 described below may be used to co-ordinate safe operation between said person and the first object (e.g. machinery, robots, drones etc) operating on the site.

In some embodiments, the first object is a large object for manufacture (e.g. such as a submarine, train, aircraft, spacecraft or any other large object for manufacture) and the second object is a drone. In such embodiments, the space is the three-dimensional space in which the large object is being built.

In some embodiments, the first object is a structure such as a building, bridge, infrastructure, onshore or offshore wind turbine, power plant, railway tracks, or any other structure, and the second object is a drone or other robot. In such embodiments, the space is the three-dimensional space in which the structure and the drone are located and/or operate respectively. The method 300 below may be used to enable the drone to locate a first point on the structure and perform accurate measurements, e.g. for the purpose of building monitoring or external inspection of the quality of the building, therefrom. In this way the marker at the first point can act as a reference point for remote, automated and high accuracy inspection of a structure such as a building. Thus, IR markers including but not limited to narrow-band infrared) markers can be attached to a finished article under construction for use as reference points for the remote, automated and high accuracy inspection of the structure throughout its operational life. For example, the methods herein can be used in the automated (e.g. without operator involvement) inspection of the external condition of an offshore wind turbine by a drone fitted with IR sensors, where the IR markers enable the drone to return to the same inspection vantage point to high precision and hence compare the progression with time of for example cracks, paint deterioration, movement etc.

Although examples where first and second objects are employed in the space are described herein, it will be appreciated that the methods herein can be extended to locate, track and provide real-time instructions to any number of objects in the space.

Although many embodiments herein relate to construction sites and manufacturing applications, it will further be appreciated however, that the techniques described herein can be applied equally to other scenarios in which objects are tracked. For example, in some embodiments, the first object is a person. Thus, the embodiments herein can be used to track people or animals. As an example, the systems and methods herein facilitate accurate tracking of footballers on a football pitch, or horses on a horseracing track. Thus, the space referred to above can be a football pitch, a horseracing track, or any other three-dimensional volume in which it is desirable to track people or animals.

It will further be appreciated that embodiments herein can equally be applied to vehicles, for example, the first object can be a race car. In such an example the space would be a racetrack. As another example, the first object can be a drone, and the space can be a fly-zone for the drone.

As another example, the first object can be a vehicle and the space can be a portion of a road along which the vehicle is travelling. In such embodiments, the vehicles can be fitted with the markers described herein and the IR sensor(s) can be fitted on road-side infrastructure, such as lamp-posts or gantry. The method 300 can be used to track the vehicles passing through the space in view of the road-side infrastructure. In such examples, the narrow-band infrared filters described herein can advantageously be used to track vehicles at high accuracy over longer distances compared to other methods of vehicle tracking. Thus, the methods herein can be used as part of smart-road infrastructure to monitor and send instructions to vehicles. The methods herein can thus be used in conjunction with the inventions described in WO2021/051008A, WO2022/003343A and WO2022/074406A (the contents of which are incorporated herein by reference).

The embodiments herein can be applied to manned or unmanned, automated, semi-automated, or manual vehicles. Examples of vehicles include but are not limited aerial vehicles (such as aeroplanes, drones, helicopters, airships, gliders and/or any other aerial vehicle), land vehicles (such as manned or driverless cars, lorries, motor-bikes, vans and/or any other road-based vehicles) and water vehicles (such as boats, container ships, liners, sailboats and/or any other water-borne vehicles). The methods herein can thus be used to track and/or send instruction data to control vehicles in air, on land or in water spaces.

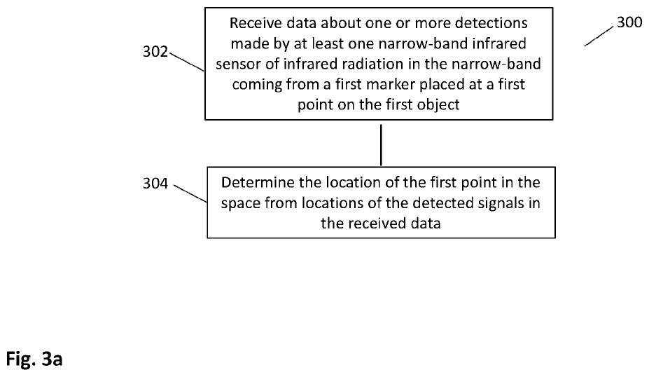

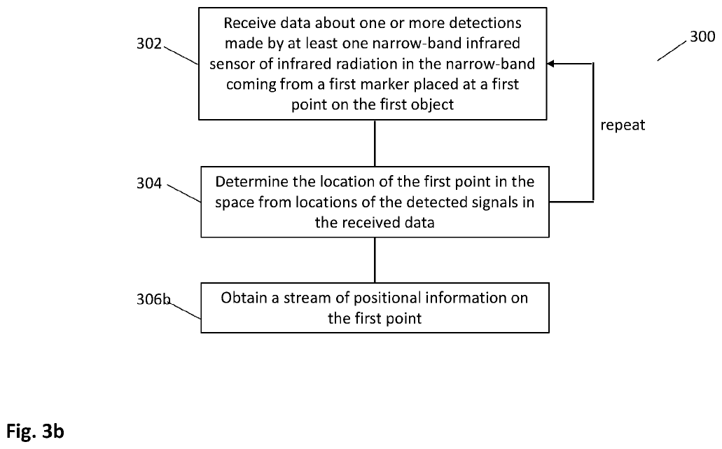

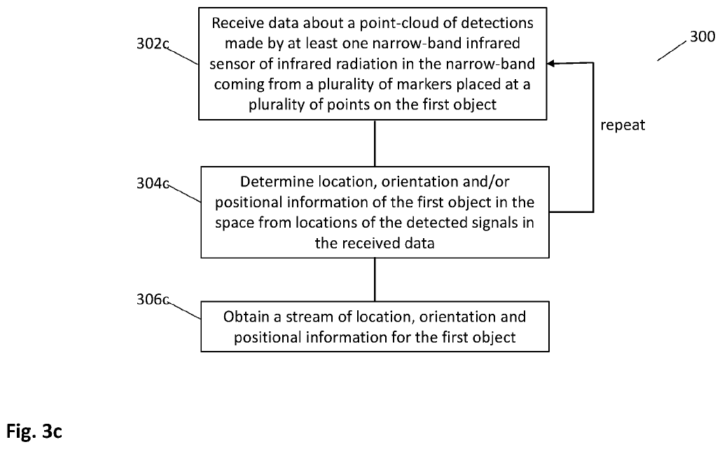

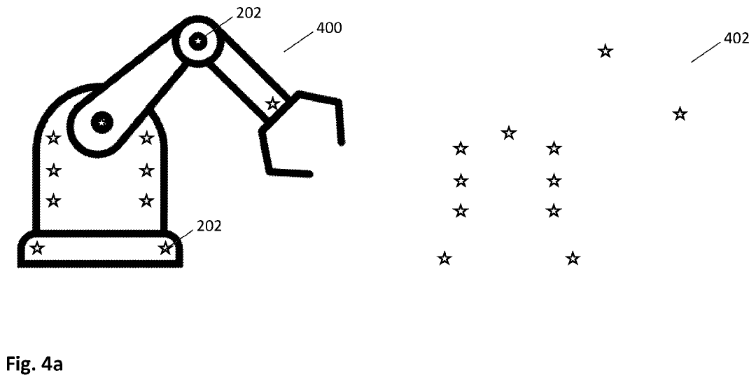

Turning now to FIG. 3a, there is a computer implemented method 300 of detecting a first object in a space according to some embodiments herein. The method 300 can be performed by the computer node 100 described above. The method 300 can be applied to detecting and monitoring a wide variety of object types in a wide variety of spaces, as described in the examples above. Briefly, the method 300 comprises: i) receiving 302 data about one or more detections made by at least one infrared sensor of infrared radiation coming from a first marker placed at a first point on the first object. In a second step the method comprises ii) determining 304 the location of the first point in the space from locations of the detected signals in the received data. In some embodiments herein, in step 302, the data is received from a narrow-band infrared sensor, and the data indicates one or more detections made by said narrow-band sensor of infrared radiation in the narrow-band coming from the first marker.

The data received in step 302 indicates one or more detections of infrared radiation in the narrow band, from (e.g. emitted from or reflected off of) the first marker on the first object. The data may be obtained from more than one infrared sensor. In such examples, the different infrared sensors may have different vantage points into the space.

The data may be in the form of infrared images (such as near-infrared images) showing an infrared photograph of the space. In examples where the data is infrared images, then the method may comprise pre-processing steps, such as image-processing steps (such as image segmentation and the like) to identify the first marker in the image(s). In other examples, the data may comprise a file indicating the location and/or intensity of sources of infrared in the space. These are merely examples however, and any other data from which the relative positions of infrared sources in the images may equally be used.

In step 304, the method 300 comprises ii) determining 304 the location of the first point in the space from locations of the detected signals in the received data. The location of the first point in the space can be determined, for example, using techniques such as triangulation or multilateration. The skilled person will be familiar with the principles of triangulation, whereby detections of the first marker made by two or more different IR sensors with different vantage points (or viewing perspectives) into the space can be used to determine the location of the first marker, based on the offsets in location perceived by the different IR sensors. Thus, in this way, the position of the first marker can be determined in an accurate, fast manner, even at long distances, in poor weather conditions or at night. It will be appreciated that location measurements from triangulation will be relative locations, however relative location data can be converted to absolute location data if the absolute locations of the IR sensors is known.

It will be appreciated that steps i) and ii) can be repeated in an iterative manner to track movements of the first point on the first object over time. For example, as illustrated in FIG. 3b, the method 300 may repeated to obtain 306b a stream of positional data for the first marker. Iterative as used herein, may mean continuously, or near-continuously (according to the limits of computing power). One of the advantages of the methods herein is the comparatively low levels of computing power needed to determine the locations using IR. This is due to the high S/N of the signals involved (particularly where narrow-bands IR detections are used). Thus, the methods herein permit rapid and computationally inexpensive streams of positional information to be obtained.

As such, a stream of location data may be obtained in real-time (or near-real time). Tracking the location of a single point in this manner can be useful in a range of scenarios, including but not limited to, tracking the location of a drone in a factory or construction setting; tracking the location of a person in a factory or construction setting; tracking footballers on a football pitch, tracking cars on a road, or in any other scenario where a single point can be used to track an object.

In embodiments where the first point is on a moving part of a machine, then the method 300 may be used to accurately, continuously and with low latency, measure the position of the major moving components of plant and machinery—for example robot arms, excavator limbs, tipper elevations, and/or crane hooks, etc.

In some embodiments, as noted above, there will be more than one marker attached to the first object and thus more than one marker may be visible to the Infrared sensor(s) at any one time. Thus, in some embodiment, the method 300 may further comprise repeating steps i) and ii) for infrared radiation coming from two or more different markers placed at two or more different points on the first object to determine two or more locations on the first object. It will be appreciated that steps i) and ii) do not have to be repeated for each marker in sequence (e.g. one after another), for example, step i) may be performed for all the markers in one go, followed by step ii) for all the markers in one go. In other words, steps i) and ii) may be performed as parallel computing processes.

Two or more markers may be used in a variety of embodiments, for example, IR markers may be attached to the components of an article under construction as reference points for the fabrication, assembly, construction or manufacture of the final article. As another example, markers may facilitate the precise mating of major assemblies on a ship or an aircraft production line or the assembly of prefabricated building sections on a construction site.

In some embodiments, a plurality of markers may be applied to the first object, and when detected, these may form a point-cloud of (e.g. narrow-band) IR detections. A method of processing a point-cloud is illustrated in FIG. 3c. In step 302c, the method 300 may comprise receiving data about a point-cloud of detections made by at least one narrow-band infrared sensor of infrared radiation in the narrow-band coming from a plurality of markers placed at a plurality of points on the first object. In step 304c, location, orientation and/or positional information of the first object in the space is determined from locations of the detected signals in the received data. Steps 302c and 304c are repeated to obtain 306c a stream of such location, orientation and positional information for the first object. As used herein, the location may comprise the x, y, z co-ordinates of the object in the space; the orientation may relate to e.g. the pitch, yaw, and roll of the object, and the positional information may relate to the position or “posture” of any articulated parts on the first object.

Thus, the data may comprise the locations of a plurality of markers in the images, e.g. in the manner of a “point-cloud” of markers. The skilled person will be familiar with point-clouds and different methods that may be used to map the location, orientation and/or positional information of a three-dimensional surface or structure from a point-cloud.

As an example, the points in the point-cloud may be mapped (or fit) to a model of the object, to determine, for example, where a particular part of the first object (lever, arm, mechanical connector etc) is located. An example of a suitable model is a three-dimensional deformable mesh structure whereby each vertex in the mesh corresponds to a marker on the first object. Movements of the object can thus be represented by deformations of the three-dimensional mesh structure. Such a mesh will have some static and some dynamic points (to accommodate the fixed and articulated parts of the first object respectively), but with constrained and known degrees of freedom, in the machine body reference frame. The model of the object can link back to the design model of the machine tool (e.g. in 3D CAD) and the emitters/reflectors can be designed in and analysed to optimise machine tool tracking.

Furthermore, certain markers can act as “anchor” points (or boundary conditions) for the fitting process, for example, markers having a unique pattern or frequency of IR reflection or emission can be associated with particular points in the mesh. It will be appreciated that constraints on the permitted deformations of such meshes can be applied, according to the range of permitted movements and articulations of the first object. In this manner, embodiments herein use what might be thought of as a ‘tailored point cloud’ based on emitters/reflectors at a priori known points on a machine tool and structure. The tailored point cloud has advantages over methods such as Lidar scanning (which results in very complex point clouds e.g. 200×200 dots, each with a distance to the reflecting surface) or photogrammetry because the point cloud can be designed to maximise efficiency of computation so that the mesh can be fit much faster and with near-zero latency allowing closed loop machine control.

Furthermore, triangulation, as described above, may be used to determine the locations of one or more of the markers, by comparing the locations of detections of the markers in two or more different images of the markers taken from different vantage points. In examples where there are large numbers of markers and issues arise with respect to the identification of individual markers in each image, then the signals from the markers may be distinguished from one another, e.g. in frequency, or pattern of emission.

As another example, machine learning may be used to predict location, orientation, and positioning information of an object from a point cloud of points.

The skilled person will be familiar with machine learning and methods of training a model using a machine learning process. But in brief, a model, which may otherwise be referred to as a ‘machine learning model’ comprises a set of rules or (mathematical) functions that can be used to perform a task related to data input to the model. Models may be taught to perform a wide variety of tasks on input data, examples including but not limited to: determining a label for the input data, performing a transformation of the input data, making a prediction or estimation of one or more output parameter values based the input data, or producing any other type of information that might be determined from the input data.

In supervised machine learning, the model learns from a set of training data comprising example inputs and corresponding ground-truth (e.g. “correct”) outputs for the respective example inputs. Generally, the training process involves learning values of weightings or bias values of the model, so as to tune the model to reproduce the ground truth outputs for the input data. Different machine learning processes are used to train different types of model, for example, machine learning processes such as back-propagation and gradient-descent can be used to train neural-network models.

The model herein may generally be any type of machine learning model that can be trained to take as input, a point cloud of IR signals (or data indicative of such a point cloud), as described above, and output a prediction of the location, orientation and/or positional/postural information of the first object. Examples of suitable models include but are not limited to: neural network models, linear regression models and decision tree models.

In some examples, the model is a neural network. There are various open-source neural network models that are suitable for use in the embodiments described herein, such as, for example, the neural network in scikit-learn, which is described in the paper entitled: Scikit-learn: Machine Learning in Python, Pedregosa et al., JMLR 12, pp. 2825-2830, 2011. Generally, the features herein can be obtained using the default neural network parameter settings described in the guidance.

There are different possible combinations of input and output parameters. As an example, the input may be in the form of an image, e.g. an image showing the point cloud. Such an image may be complemented by additional data, for example, such as the location or other identification of the IR sensor that made the detections. As another example, the input may be a list of vectors corresponding to the central points of each detected IR signal in the point cloud. In other examples still, the input may be raw data from the IR sensors. The skilled person will appreciate that these are merely examples, and that other inputs may be provided, additionally or alternatively to those described above.

A neural network may also take as input, data related to previous location, orientation and/or positional information of the first object. As this information is strongly causally connected to the current location, orientation and/or position of the first object, this can improve the predictions of the neural network.

With respect to output parameters, the neural network may be trained to output any type of location, orientation and/or positional data, such as a relative location of the first object in the space, an absolute location of the first object, a pitch, roll and/or yaw of the first object, an indication of the location of an extremity or articulated component of the first (e.g. an arm, claw, scoop or similar), or any other information related to the first object's location, orientation or mechanical posture or state.

The neural network may also be trained to output other information about the first object that can be inferred from the point cloud. For example, a type of the first object (e.g. the type or make of drone, machinery, vehicle etc), its size or extent.

As noted above, a neural network can be trained using training data comprising example inputs and “correct” or ground-truth outputs for the example inputs. A training dataset can be built up in various ways. For example, by simulating the first object at different positions, e.g. different distances, angles and orientations from a viewpoint, and simulating corresponding point-clouds for each location and position. Such simualtions may be performed using a Computer Aided Design (CAD) tool. The training dataset may be built up in a systematic manner by sequentially sampling the full possible “location/orientation/position” space available to the first object in the physical space. In this way, a training set can be built up that can train the neural network with high accuracy in a wide-range of scenarios.

It will be appreciated that if further input parameters are provided, the training dataset might be extended to sample the possible positions and resulting patterns created in view of the additional parameter(s) (and parameter space) e.g. such as the point clouds created through the use of different IR marker combinations (e.g. that emit with different frequencies, pulsed signals or coded signals, etc).

It will further be appreciated that the training set may comprise point-clouds representing more than one object. For example, the neural network may be trained to predict different types of interactions (or mutual manoeuvres) of first and second objects, and/or to output proximity alerts and the like, if a point cloud is in input that indicates that the first and second objects have become too close together.

It will further be appreciated that a training dataset can be built up from real-life measurements, for example, by observing the point clouds observable when the first object performs different manoeuvres and recording the resulting point-clouds and location/orientation/positional data, for use in building up a training dataset. It will further be appreciated that a training dataset can also be made up of a combination of real data and simulated data.

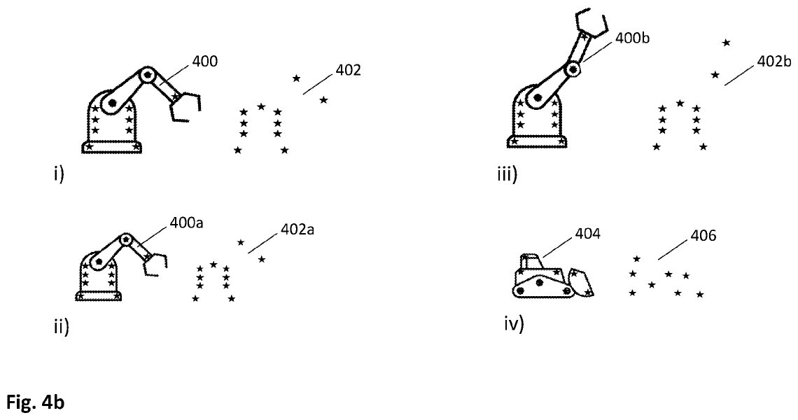

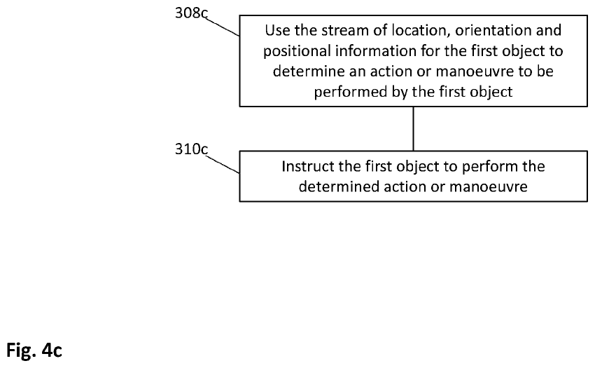

Some example pairs of location and point clouds are shown in FIG. 4b (which is also discussed below). In this example, a first object in the form of a machine 400 is shown in a first location and position in FIG. 4b i) alongside its point-cloud 402. The same object, detected at a more distant location with the same posture 400a is illustrated in FIG. 4b ii) with its associated point cloud 402a. FIG. 4b iii) shows the same machine in a different posture 400b alongside its associated point cloud 402b. FIG. 4b iv) shows a second object in the form of a truck 404 and its associated point cloud 406. Thus, in this example a training data set may be made up of different objects in different postures at different locations.

Various further example algorithms that might be modified for the purposes herein are described in the following papers:
“LBS Autoencoder: Self-supervised Fitting of Articulated Meshes to Point Clouds” (2019) Chun-Liang Li, Tomas Simon, Jason Saragih, Barnabas Poczos', Yaser. This paper uses an auto-encoder to fit a deformable, articulated mesh to a point cloud. These types of techniques might be used in embodiments herein to obtain location data of moving parts, such as mechanical arms of a robot or machinery.
“Keep it SMPL: Automatic Estimation of 3D Human Pose and Shape from a Single Image” Federica Bogo, Angjoo Kanazawa, Christoph Lassner, Peter Gehler, Javier Romero, Michael J. Black. In ECCV, 2016. This paper describes methods of determining pose of a human. This could be generalised to determining the pose of a mechanical object, from a point cloud.
“PointNet: Deep Learning on Point Sets for 3D Classification and Segmentation” Charles R. Qi, Hao Su, Kaichun Mo, Leonidas J. Guibas (2017). Describes an algorithm whereby the points in a point cloud are fed directly to a neural network that can be trained to clarify an object. Such a neural network might be trained to classify based on position of an object.

It will be appreciated that the papers cited above are merely examples and that other methods for identifying an object and its position from a point cloud of IR signals reflected and/or emitted from IR markers may equally be used.

In this way, a plurality of markers, as described above, can be used to generate a point-cloud of the first object, from which the location, orientation and positional information of the first object can be determined.

By repeating the method 300 over time, in an iterative manner (for example, frame after frame on IR digital video data of the first object), the location can be tracked and monitored over time to determine motion parameters such as, speed, trajectory and acceleration of the first object.

As noted above, the point cloud may also be processed to determine the orientation of the first object. For example, if the first object is a drone, then the point-cloud may be used to determine the pitch, yaw and roll of the drone (for example, this information may be output from the models cited above). Thus, the method above can be used to track an object and determine its position, orientation and motion properties in real-time.

In some embodiments, the location, orientation and positional information can be used to send instructions to the first object. For example, to instruct the first object to perform an action or manoeuvre. Examples of instructions that may be sent to cause the first object to perform a manoeuvre include but are not limited to: instructions to accelerate, stop, start or turn, to articulate an arm or moving part of the first object. Examples of instructions that may be sent to cause the first object to perform an action include but are not limited to, actions relating to fixing two parts together, to disengaging one part from another, actions associated with a mechanical arm (scoop, lift, tip etc), wield etc, or any other action that can be performed by the first object.

Thus, in embodiments where the first object is a robot, drone or mechanical object for use in a factory or construction setting, the method 300 described above can be used to monitor the first object and provide instructions to the first object as part of an automated factory or automated construction program.

Turning now to other embodiments, as described above, these principles can be applied to more than one object, and the resulting data can be used to determine and co-ordinate interactions between said objects. For example, in some embodiments, the method 300 can comprise repeating steps i) and ii) for a second marker placed on a second point on a second object, to determine the location of the second point in the space. The determined locations of the first marker and the second marker can then be used to determine a relative proximity of the first object and the second object.

The relative proximity can be used to initiate a proximity warning (e.g. to an operator or other system), or to send a command to halt or change movement of the first object or the second object, in response to determining that the relative proximity is less than a first threshold proximity. In embodiments where the first object is moving machinery and the second object is a person, then the method 300 can be used to accurately, continuously and with low latency, measure the position of human operatives working in proximity with moving machines. Such information may be used to deliver proximity warnings to human operatives or adjacent persons or to provide the basis for safety interlocks that will reduce accident levels and/or reduce the economic impact of inadvertent collisions.

It will be appreciated that a first plurality of markers can be placed on the first object and a second plurality of markers can be placed on the second object, resulting in detections of first and second point-clouds respectively. The point-clouds may each be processed using any of the techniques described above (e.g. via triangulation, by fitting a deformable meshes to each point-cloud and/or using machine learning), to determine relative locations, orientations and positional/postural information for the first and second objects respectively.

The processes can be made more efficient by, for example, distinguishing the first plurality of markers from the second plurality of markers, using e.g. different pattens or frequencies for each plurality of markers. Furthermore, the markers in the first plurality of markers may be configured to emit or reflect IR radiation at staggered intervals to the second plurality of markers, so that only one plurality of markers is visible at any one time to the IR detectors. Thus, the first plurality of markers may appear to “flash” followed by the second plurality of markers. If the frequency of the flashes is high enough, then each object may still be tracked in real-time.

In other embodiments, the relative proximity and/or the location, orientation and positional/postural information can be used to co-ordinate a manoeuvre between the first and second objects. For example, the method 300 can be used to guide a mechanical arm of first object (such as a robot or machine) toward a particular point on a second object under manufacture; to guide a first object in the form of a robot in fitting a first component to a particular portion of a second article under construction; to guide a pair of robots in a refuelling manoeuvre; to guide an automated truck in a loading procedure; or to guide any other automated-or semi-automated process between two objects. Thus, the method 300 can be used to deliver higher levels of automation in the processes of fabrication, assembly, construction and manufacture.

FIG. 4a shows a first object 400 in the form of machinery for use in a factory or construction site, having a plurality of markers 202. When detected by an infrared detector 204, the plurality of markers result in a point-cloud 402. As noted above, the appearance of the point-cloud will change depending on the vantage point of the IR detector 204, and thus different vantage points can be used to determine the location of the points, using the principles of triangulation, or any of the other techniques described above. In this embodiment, the method 300 as illustrated in FIG. 3c can be applied to the point cloud to obtain a stream of location, orientation and positional information for the first object (e.g. the machinery).

FIG. 4b illustrates example point clouds observable for the machinery in FIG. 4a, and how the point cloud changes with increased distance (in FIG. 4b ii)) and articulation of the mechanical arm (in FIG. 4b iii). FIG. 4b iv illustrates a point cloud associated with a second object. Such object-point cloud pairs can be used as training data with which to train a machine learning model (such as a neural network) to take a point-cloud as input and provide as output a prediction of machine-type and/or orientation, as described above.

In this embodiment, the method in FIG. 3c can further comprise steps 308c and 310c as illustrated in FIG. 4c, whereby the stream of location, orientation and positional information output by the method steps illustrated in FIG. 3c are further used to determine an action or manoeuvre to be performed by the first object (e.g. using techniques such as reinforcement learning, pre-programmed rules, optimisation or any other suitable process), and in step 310c, the first object is instructed to perform the determined action or manoeuvre.

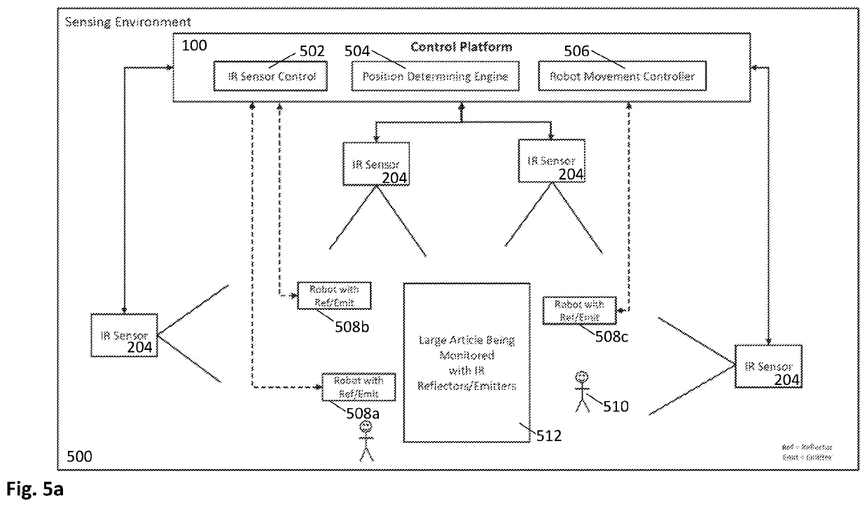

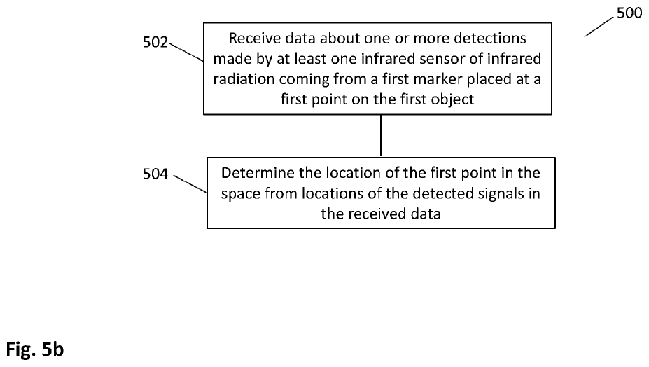

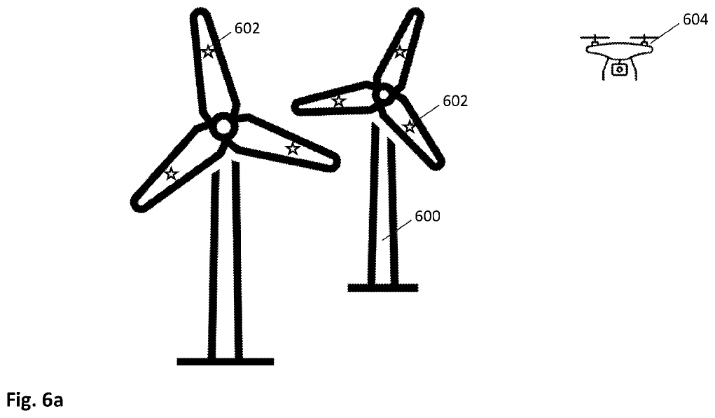

FIG. 5a shows an example system for use in some embodiments herein. In this embodiment, the space or “sensing environment” 500 is a factory or construction site, where a large article (e.g. such as a train, submarine, component of a bridge etc) 512 is being manufactured. The large article 512 has a plurality of markers on its surface (the markers may emit or reflect IR radiation). IR sensors 204 are positioned at different points in the space and send data on detections of the markers on the large article 512 to a computer node 100. In this embodiment, the IR sensors can be broad-band or narrow-band IR sensors, as described above. In this embodiment, the computer node 100 comprises three computing modules. An IR Sensor Control module 502 for performing step 302 and receiving data about one or more detections made by at least one narrow-band infrared sensor of infrared radiation in the narrow-band coming from a first marker placed at a first point on the first object. The IR sensor module 502 repeats step 302 for data relating to detections of each marker on the large article 512. The received data is sent to a Position Determining Engine 504 which performs step 403 and determines the location of each of the points corresponding to the markers in the space from locations of the detected signals in the received data. The Position Determining Engine 504 can employ any of the techniques described above in relation to step 504 for determining location information from one or more markers on an object (e.g. triangulation, fitting of a mesh-based model, and/or machine learning).

The IR Sensor Control module 502, and the Position Determining Engine 504, perform the same processes for markers on various robots 508a, 508b and 508c that are working on the construction of the large article 512. The method 300 is used to determine locations, orientations and positional information for (e.g. articulation of the parts of) each of the robots 508a, 508b and 508c.

A Robot Movement Controller module 506 uses the determined locations, orientations and posture information to determine e.g. orientation and/or positioning/postural information about the robots and determines actions to be performed by the robots in the construction of the large article 512.

Markers may also be placed on the people 510 working in the space 500, in order to track their movements in relation to the robots 508a, 508b and 508c. In this way, proximity alerts can be issued if someone gets too close to the automated machinery.

A method of detecting a first object, wherein the first object is a robot, drone or other machinery in a manufacturing or construction space, is illustrated in FIG. 5b. The method comprises, in step 502, receiving data about one or more detections made by at least one infrared sensor of infrared radiation coming from a first marker placed at a first point on the first object. In step 504, the method 500 then comprises determining the location of the first point in the space from locations of the detected signals in the received data.

There is thus provided a system for facilitating an automated factory or construction site. It will be appreciated that the details above are merely an example and that the computer node 100 may comprise a different number, or different combination of modules to those illustrated in FIG. 5a. Furthermore, there may be different numbers of robots and/or IR sensors to those depicted in the Figure.

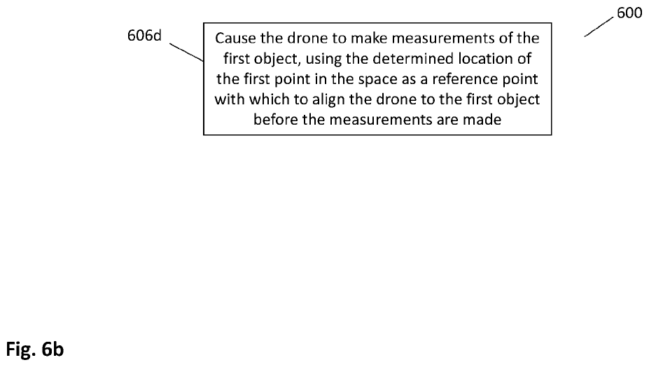

Turning now to FIG. 6, which illustrates embodiments herein whereby markers are used as reference points in construction, monitoring or inspection of a large object such as a building, bridge, sky scraper, or as illustrated in FIG. 6, a wind turbine.

During construction, IR markers may be attached to the components of the article under construction as reference points for the remote, automated and high accuracy inspection of the final product. For example, the inspection of the external condition of a high-rise building by a drone fitted with IR sensors.

However, markers can further be used to monitor a finished article during its lifetime. IR markers can be attached to an object as reference points for the remote, automated and high accuracy inspection of the object throughout its operational life, both day and night and in a wide range of weather conditions. For example, as illustrated in FIG. 6a, markers 602 may be placed on a wind-turbine 600 for the automated (ie without operator involvement) inspection of the external condition of the wind turbine 600 by a drone 604 fitted with IR sensors, and configured to perform the method 300 to locate the markers 602 and to enable the drone 604 to return to the same inspection vantage point with high precision and hence to be able to compare the progression with time of, for example, cracks, and paint deterioration. Thus, in this way, the method 300 can be used to perform accurate comparative inspections of large structures over time, even in adverse conditions such as off-shore wind turbines, whether or not the turbine blade is rotating. If the turbine blade is rotating (e.g. the first object is moving), then the location may be tracked using the method 100 throughout the movement.

FIG. 6b shows a step that can be performed by a computer node 100 in the embodiment illustrated in FIG. 6a. In this embodiment, the computer node performs steps 302 and 304 of the method 300 as illustrated in FIG. 3. In this embodiment, the data in step 302 is received from the drone 604 and is used in step 304 to determine the location of a first point on the wind turbine. The computer node 300 then performs step 306d as illustrated in FIG. 6b and causes the drone to make measurements of the first object, using the determined location of the first point in the space as a reference point with which to align the drone to the first object before the measurements are made. The computer node 100 may cause the drone to make the measurements by e.g. sending instructions to the drone.

Turning now to other embodiments, it will be appreciated that the method 300 may be embodied in a computer program. For example, a computer program product may comprise a computer readable medium, the computer readable medium having computer readable code embodied thereon. The computer readable code can be configured such that, on execution by a suitable computer or processor, the computer or processor is caused to perform the method or methods described herein (such as the method 300).

A computer program may take different forms, for example, source code, compiled code, executable code, or any other type of code. It will be appreciated that the source code of computer programs may be written in a wide variety of different programming languages, and may take different architectural designs. For example, the functionality described herein may be split across various different sub-routines. Furthermore, the skilled person will appreciate that many different ways of splitting the functionality between the different sub-routines will be possible. The sub-routines may be stored together in one executable file to form a self-contained program. Furthermore, computer programs may call external and/or standard libraries of computer code for performing certain sub-tasks associated with the functionality described herein.

In another embodiment, there is a computer program product comprising non-transitory computer readable media, having stored thereon a computer program as described above. Examples of computer readable media include, but are not limited to: ROM, such as a CD ROM, a semi-conductor ROM or a magnetic recording medium such as a hard disk.

In another embodiment, there is a carrier containing a computer program. Examples of carriers include but are not limited to an electronic signal, optical signal, radio signal, computer storage medium, or similar. The carrier of a computer program may be any entity or device (e.g. hardware) capable of carrying the program. As an example, a carrier may be a computer readable media as described above. In other examples a carrier may be a transmissible carrier such as an electronic or optical signal, which may be conveyed via electrical or optical cable or by radio or other means.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these claims cannot be used to advantage. Any reference signs in the claims should not be construed as limiting the scope. Furthermore, it will be understood that features, advantages, and functionality of the different embodiments described herein may be combined without departing from the spirit or scope of the disclosure herein.

1. A computer implemented method of detecting a first object in a space, the method comprising:
i) receiving data about one or more detections made by at least one narrow-band infrared sensor of infrared radiation in the narrow-band coming from a first marker placed at a first point on the first object; and
ii) determining the location of the first point in the space from locations of the detected signals in the received data.

2. The method of claim 1 wherein the narrow-band signal is centered at about 800 nm with a frequency range of about +/−10 nm or a frequency range of about +/−20 nm.

3. The method of claim 1, further comprising:
repeating steps i) and ii) in an iterative manner to track movements of the first point on the first object over time.

4. The method of claim 1, further comprising:
instructing an infrared emitter to emit pulses of infrared radiation into the space wherein the pulses are emitted with a first frequency of pulsation; and
wherein steps i) and ii) are repeated for detections of reflections of each pulse from the first marker.

5. The method of claim 4, wherein the pulses are emitted with a frequency of pulsation between about 60 and about 100 Hz.

6. The method of claim 1, further comprising:
repeating steps i) and ii) for infrared radiation coming from two or more different markers placed at two or more different points on the first object.

7. The method of claim 1, wherein step i) comprises:
receiving data about a point-cloud of detections made by at least one narrow-band infrared sensor of infrared radiation in the narrow-band coming from a plurality of markers placed at a plurality of points on the first object.

8. The method of claim 7 further comprising in step ii):
determining, from the point cloud, an orientation, position or posture of the first object in the space.

9. The method of claim 8, further comprising:
using the stream of location, orientation and positional information for the first object to determine an action or maneuver to be performed by the first object; and
sending a control signal to the first object, to cause the first object to perform the action or maneuver.

10. The method of claim 1, further comprising:
repeating steps i) and ii) for a second marker placed on a second point on a second object, to determine the location of the second point in the space; and
using the determined locations of the first marker and the second marker to determine a relative proximity of the first object and the second object.

11. The method of claim 10, further comprising:
initiating a proximity warning; or
sending a command to halt or change movement of the first object or the second object, in response to determining that the relative proximity is less than a first threshold proximity.

12. The method of claim 1, wherein the first object is a robot, drone, mechanical object or person.

13. The method of claim 1, wherein the space is one of a construction site, a factory, or a field.

14. The method of claim 1, wherein the first object is one of a building, a bridge, or a wind-turbine.

15. The method of claim 1, wherein the second object is one of a second robot, a second drone, or a human.

16. The method of claim 1, wherein the data in step i) is received from a drone and wherein the method further comprises:
causing the drone to make measurements of the first object, using the determined location of the first point in the space as a reference point with which to align the drone to the first object before the measurements are made.

17. The method of claim 1, wherein the step of determining the location of the first marker comprises:
triangulating the location from the detected signals in the received data.

18. The method of claim 1, wherein the method is performed at night, outdoors or in adverse weather conditions.

19. A computer node for tracking a first object in a space, the node comprising:
one or more computer processors configured to:
i) receive data about one or more detections made by at least one narrow-band infrared sensor of infrared radiation in the narrow-band coming from a first marker placed at a first point on the first object; and
ii) determine the location of the first point in the space from locations of the detected signals in the received data.

20. The computer node of claim 19, wherein the narrow-band is centered at about 800 nm with a frequency range of about +/−10 nm or a frequency range of about +/−20 nm.

21. A system for tracking a first object in a space, the system comprising:
a first marker placed at a first point on the first object;
at least one narrow-band infrared sensor comprising a narrow-band infrared filter to detect infrared radiation in the narrow-band; and
a computer node configured to:
i) receive data about one or more detections made by the at least one narrow band infrared sensor of infrared radiation in the narrow-band coming from the first marker; and
ii) determine the location of the first point in the space from locations of the detected signals in the received data.

22. The system of claim 21, wherein the narrow-band infrared filter is centered at about 800 nm with a frequency range of about +/−10 nm or a frequency range of about +/−20 nm.

23. The system of claim 21, wherein the marker comprises one of an infrared emitter, a reflective material, or a retroreflective material.

24. The system of claim 21, wherein the system further comprises:
one or more infrared lamps configured to illuminate the space with infrared radiation so as to cause infrared radiation to be reflected from the marker.

25. The system of claim 24, wherein the one or more infrared lamps are configured to emit pulses of infrared radiation with a first frequency of pulsation, and wherein the computer node is configured to repeat steps i) and ii) for each pulse.

26. The system of claim 21, wherein the computer node is further configured to repeat steps i) and ii) in an iterative manner to track movements of the first point on the first object over time.

27. A method for tracking a first object, wherein the first object is a robot, drone or other machinery in a manufacturing or construction space, the method comprising:
i) receiving data about one or more detections made by at least one infrared sensor of infrared radiation coming from a first marker placed at a first point on the first object; and
ii) determining the location of the robot, drone or other machinery in the space, from locations of the detected signals in the received data.

28. A computer node for detecting a first object, wherein the first object is a robot, drone or other machinery in a manufacturing or construction space, the node comprising:
one or more processors configured to:
i) receive data about one or more detections made by at least one infrared sensor of infrared radiation coming from a first marker placed at a first point on the first object; and
ii) determine the location of the robot, drone or other machinery in the space, from locations of the detected signals in the received data.

29. A non-transitory computer readable storage medium comprising stored instructions which, when executed by a computer causes the computer to:
(i) receive data about one or more detections made by at least one narrow-band infrared sensor of infrared radiation in the narrow-band coming from a first marker placed at a first point on the first object; and
ii) determine the location of the first point in the space from locations of the detected signals in the received data.

30. The non-transitory computer readable storage medium of claim 29, further comprising instructions, which when executed by the computer causes the computer to:
repeat steps i) and ii) in an iterative manner to track movements of the first point on the first object over time.
